(19) United States
(12) Patent Application Publication
(10) Pub. No.: US 2024/0267803 A1
(43) Pub. Date: Aug. 8, 2024

(54) COMMUNICATION METHOD AND USER EQUIPMENT

(71) Applicant: KYOCERA CORPORATION, Kyoto (JP)

(72) Inventors: Mitsutaka HATA, Yokohama-shi (JP); Masato FUJISHIRO, Yokohama-shi (JP)

(73) Assignee: KYOCERA CORPORATION, Kyoto (JP)

(21) Appl. No.: 18/638,426

(22) Filed: Apr. 17, 2024

Related U.S. Application Data
(63) Continuation of application No. PCT/JP2022/038729, filed on Oct. 18, 2022.

(30) Foreign Application Priority Data
Oct. 20, 2021 (JP) 2021-171717

(51) Int. Cl. H04W 36/00; H04W 36/14

(52) U.S. Cl. CPC H04W 36/008357; H04W 36/14

(57) ABSTRACT

In an aspect, a communication method is performed in a user equipment in an RRC idle state or an RRC inactive state. The communication method includes: specifying, as a candidate cell for cell reselection, a cell belonging to a frequency supporting a selected network slice group selected in accordance with a priority provided by a NAS layer; and determining whether the candidate cell supports the selected network slice group. The determining includes: receiving a system information block from a serving cell of a user equipment for each of a plurality of network slice groups, the system information block including information indicating an identifier of the network slice group and a cell identifier of a cell that does not support the network slice group; and determining whether the candidate cell supports the selected network slice group, based on the information.

### RELATED APPLICATIONS

The present application is a continuation based on PCT Application No. PCT/JP2022/038729, filed on Oct. 18, 2022, which claims the benefit of Japanese Patent Application No. 2021-171717 filed on Oct. 20, 2021. The content of which is incorporated by reference herein in their entirety.

### TECHNICAL FIELD

The present invention relates to a communication method and a user equipment used for a mobile communication system.

### BACKGROUND OF INVENTION

In specifications of the Third Generation Partnership Project (3GPP), which is a standardization project for mobile communication systems, Network Slicing has been defined (for example, see Non-Patent Document 1). Network slicing is a technique for creating a plurality of virtual networks (network slices) by logically dividing a physical network constructed by an telecommunications carrier.

A user equipment in a radio resource control (RRC) idle state or an RRC inactive state performs a cell reselection procedure. In the 3GPP, slice-specific cell reselection is under study. In such slice-specific cell reselection, for example, it is assumed that the user equipment preferentially reselects (that is, camps on) a cell belonging to a frequency having a high frequency priority associated with a network slice that the user equipment wants to use.

### CITATION LIST

### Non-Patent Literature

Non-Patent Document 1: 3GPP TS 38.300 V16.6.0 (2021-06)

### SUMMARY

In a first aspect, a communication method is performed in a user equipment in an RRC idle state or an RRC inactive state. The communication method includes: specifying, as a candidate cell for cell reselection, a cell belonging to a frequency supporting a selected network slice group selected in accordance with a priority provided by a NAS layer; and determining whether the candidate cell supports the selected network slice group. The determining includes: receiving a system information block from a serving cell of a user equipment for each of a plurality of network slice groups, the system information block including information indicating an identifier of the network slice group and a cell identifier of a cell that does not support the network slice group; and determining whether the candidate cell supports the selected network slice group, based on the information.

In a second aspect, a user equipment includes a processor. The processor performs: processing of specifying, as a candidate cell for cell reselection, a cell belonging to a frequency supporting a selected network slice group selected in accordance with a priority provided by a NAS layer; and processing of determining whether the candidate cell supports the selected network slice group. The processing of the determining includes: processing of receiving a system information block from a serving cell of a user equipment for each of a plurality of network slice groups, the system information block including information indicating an identifier of the network slice group and a cell identifier of a cell that does not support the network slice group; and processing of determining whether the candidate cell supports the selected network slice group, based on the information.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a base station (gNB) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram for illustrating an overview of a cell reselection procedure.

FIG. 7 is a flowchart illustrating a schematic flow of a typical cell reselection procedure.

FIG. 8 is a diagram illustrating an example of network slicing.

FIG. 9 is a diagram illustrating an overview of a slice-specific cell reselection procedure.

FIG. 10 is a view illustrating an example of slice frequency information.

FIG. 11 is a flowchart illustrating a basic flow of the slice-specific cell reselection procedure.

FIG. 12 is a diagram illustrating an operation example according to a first embodiment.

FIG. 13 is a diagram illustrating an example of slice availability information in a Variation of the first embodiment.

FIG. 14 is a diagram illustrating a Variation of the operation example according to the first embodiment.

FIG. 15 is a diagram illustrating an operation example according to a second embodiment.

FIG. 16 is a diagram illustrating a Variation of the operation example according to the second embodiment.

### DESCRIPTION OF EMBODIMENTS

In a cell belonging to a frequency associated with desired network slices, the network slices are to be provided, but, for example, a cell may temporarily fail to provide some or all network slices due to congestion or the like. That is, even for a slice support frequency capable of providing a network slice, some cells within the frequency may not provide the network slice. In this case, a user equipment may select a cell in which the desired network slice is not provided (i.e., unavailable) as a serving cell.

Therefore, the present disclosure provides a communication method and a user equipment capable of reselecting an appropriate cell in slice-specific cell reselection.

A mobile communication system according to an embodiment is described with reference to the drawings. In the description of the drawings, the same or similar parts are denoted by the same or similar reference signs.

### First Embodiment

### Configuration of Mobile Communication System

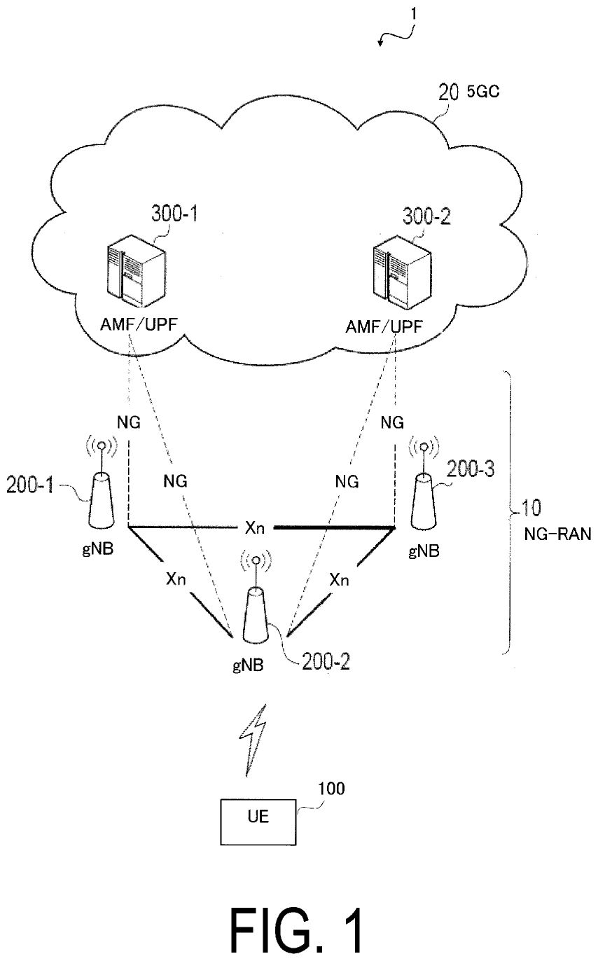

FIG. 1 is a diagram illustrating the configuration of the mobile communication system according to the first embodiment. The mobile communication system 1 complies with the 5th Generation System (5GS) of the 3GPP standard. The description below takes the 5GS as an example, but a Long Term Evolution (LTE) system or a sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as utilized by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), or a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication to the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (also simply referred to as a “frequency” below).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

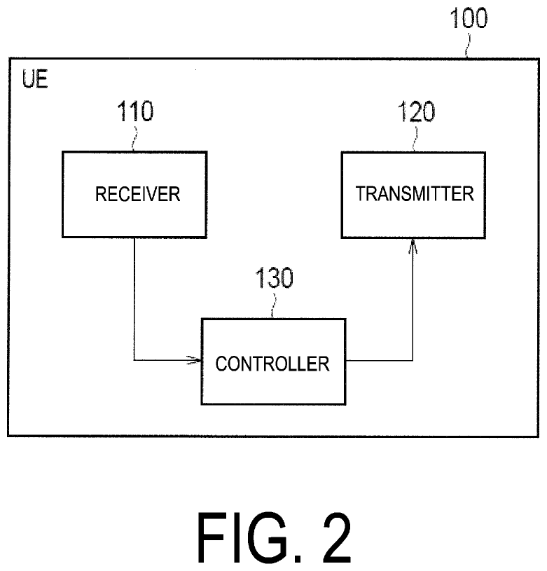

FIG. 2 is a diagram illustrating a configuration of the UE 100 (user equipment) according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processes in the UE 100. Such processing includes processing of each layer described below. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

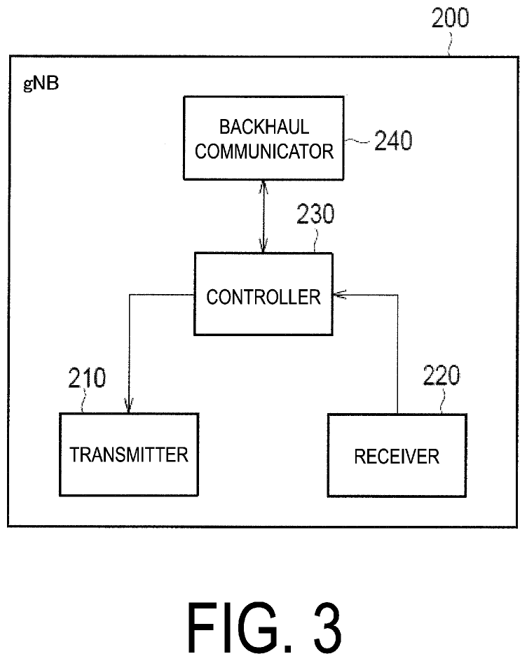

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processes in the gNB 200. Such processing includes processing of each layer described below. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the Xn interface, which is an inter-base station interface. The backhaul communicator 240 is connected to the AMF/UPF 300 via the NG interface, which is an interface between the base station and the core network. Note that the gNB 200 may include a Central Unit (CU) and a Distributed Unit (DU) (i.e., functions are divided), and the two units may be connected via an F1 interface, which is a fronthaul interface.

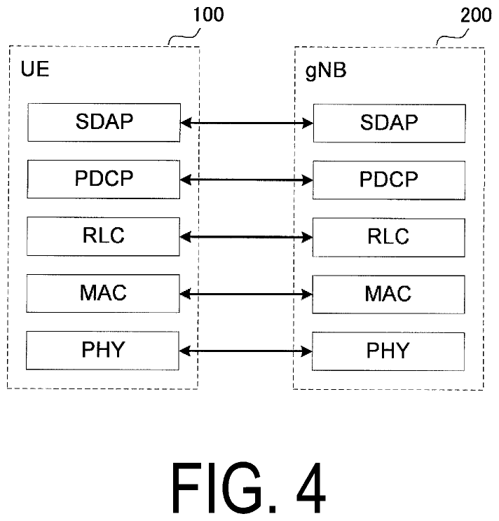

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. The PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled using the RNTI.

The MAC layer performs preferential control of data, retransmission processing using a hybrid ARQ (HARQ), a random access procedure, and the like. Data and control information are transmitted between the MAC layer of the UE 100 and the MAC layer of the gNB 200 via a transport channel. The MAC layer of the gNB 200 includes a scheduler. The scheduler determines uplink and downlink transport formats (transport block sizes, modulation and coding schemes (MCSs)), and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of QoS control by a core network and a radio bearer as the unit of QoS control by an Access Stratum (AS). Note that, when the RAN is connected to the EPC, the SDAP need not be provided.

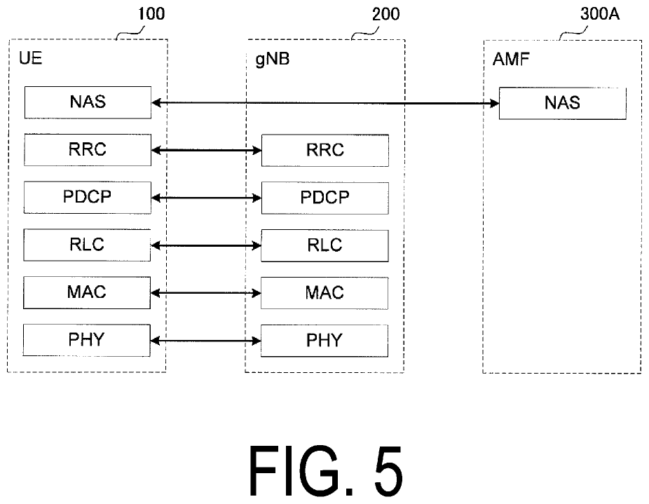

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS which is positioned upper than the RRC layer performs session management, mobility management, and the like. NAS signaling is transmitted between the NAS of the UE 100 and the NAS of the AMF 300A. Note that the UE 100 includes an application layer other than the protocol of the radio interface. A layer lower than the NAS is referred to as Access Stratum (AS).

### Overview of Cell Reselection Procedure

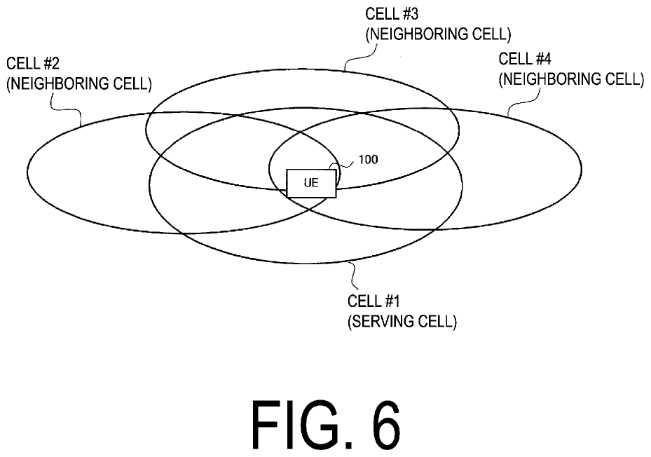

FIG. 6 is a diagram for illustrating an overview of the cell reselection procedure.

The UE 100 in the RRC idle state or the RRC inactive state while moving performs the cell reselection procedure to move from a current serving cell (a cell #1) to a neighboring cell (any one of cells #2 to #4). To be more specific, the UE 100 specifies a neighboring cell on which the UE 100 should camp through the cell reselection procedure and reselects the specified neighboring cell. When the frequency (carrier frequency) is the same between the current serving cell and the neighboring cell is referred to as an intra-frequency, and when the frequency (carrier frequency) is different between the current serving cell and the neighboring cell is referred to as an inter-frequency. The current serving cell and the neighboring cell may be managed by the same gNB 200 or may be managed by the gNBs 200 different from each other.

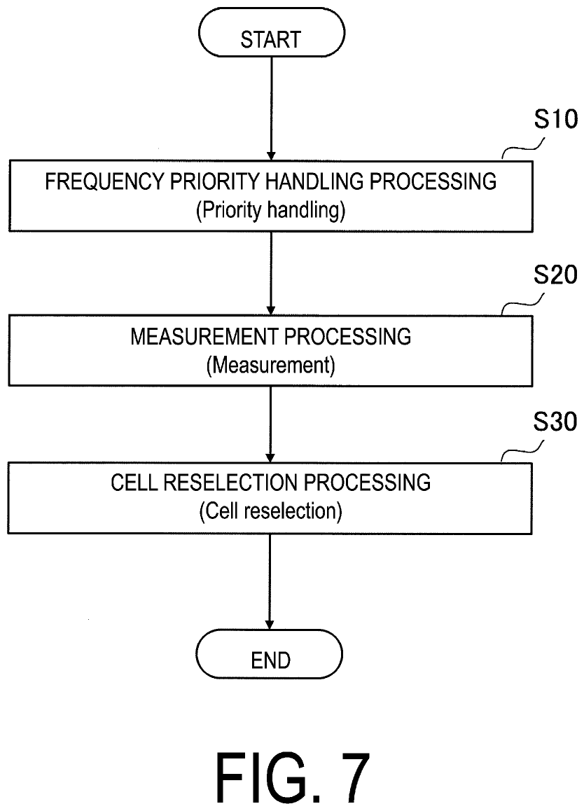

FIG. 7 is a flowchart illustrating a schematic flow of a typical cell reselection procedure.

In step S10, the UE 100 performs frequency priority handling processing based on frequency-specific priorities (also referred to as “absolute priorities”) specified by the gNB 200, for example, by way of a system information block or an RRC release message. To be more specific, the UE 100 manages the frequency priority designated by the gNB 200 for each frequency.

In step S20, the UE 100 performs measurement processing of measuring radio qualities of the serving cell and each of the neighboring cells. The UE 100 measures reception powers and reception qualities of reference signals transmitted by the serving cell and each of the neighboring cells, to be more specific, cell defining-synchronization signal and PBCH block (CD-SSB). For example, the UE 100 continuously measures the radio quality for a frequency with a priority higher than the priority of the frequency of the current serving cell, and when the radio quality of the current serving cell is lower than a predetermined quality, the UE 100 measures the radio quality for a frequency with a priority equal to or lower than the priority of the frequency of the current serving cell.

In step S30, the UE 100 performs the cell reselection processing of reselecting a cell on which the UE 100 camps based on the measurement result in step S20. For example, the UE 100 may perform cell reselection to a neighboring cell when a priority of a frequency of the neighboring cell is higher than the priority of the current serving cell and when the neighboring cell satisfies a predetermined quality standard (i.e., a minimal quality standard) for a predetermined period of time. When the priorities of the frequencies of the neighboring cells are the same as the priority of the current serving cell, the UE 100 may rank the radio qualities of the neighboring cells to perform cell reselection to the neighboring cell ranked higher than a rank of the current serving cell for a predetermined period of time. When the priority of the frequency of the neighboring cell is lower than the priority of the current serving cell, and when the radio quality of the current serving cell is lower than a certain threshold value and the radio quality of the neighboring cell is continuously higher than another threshold value for a predetermined period of time, the UE 100 may perform cell reselection to the neighboring cell.

### Overview of Network Slicing

The network slicing is a technique for virtually dividing a physical network (for example, a network including the NG-RAN 10 and the 5GC 20) constructed by an operator to create a plurality of virtual networks. Each virtual network is referred to as a network slice. Hereinafter, the “network slice” may be simply referred to as a “slice”.

The network slicing allows a communication carrier to create slices according to service requirements of different service types, such as Enhanced Mobile Broadband (eMBB), Ultra-Reliable and Low Latency Communications (URLLC), and massive Machine Type Communications (mMTC), for example, to optimize network resources.

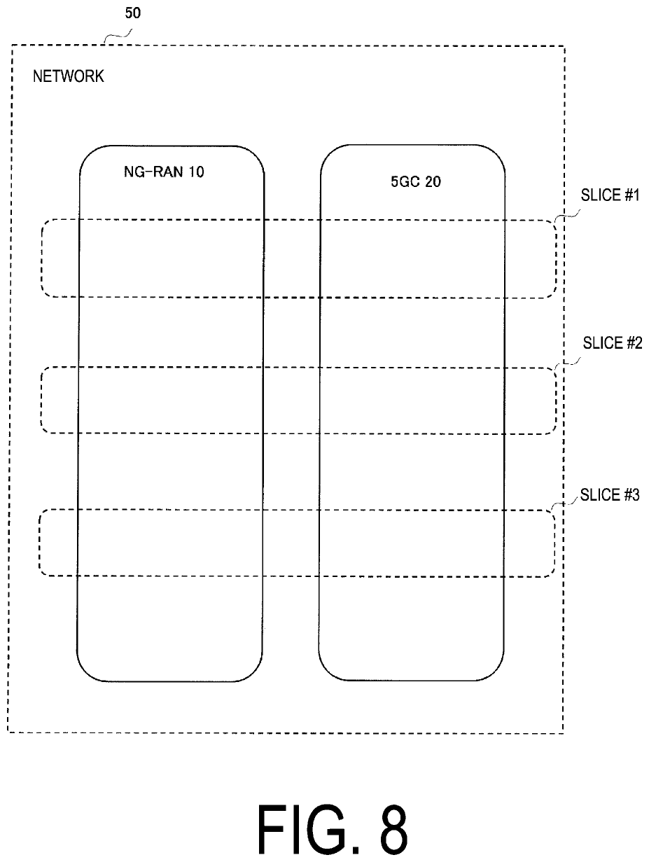

FIG. 8 is a diagram illustrating an example of the network slicing.

Three slices (slices #1 to #3) are configured on a network 50 including the NG-RAN 10 and the 5GC 20. The slice #1 is associated with a service type of eMBB, the slice #2 is associated with a service type of URLLC, and the slice #3 is associated with a service type of mMTC. Note that three or more slices may be configured on the network 50. One service type may be associated with a plurality slices.

Each slice is provided with a slice identifier for identifying the slice. Examples of the slice identifier include a Single Network Slicing Selection Assistance Information (S-NSSAI). The S-NSSAI includes an 8-bit slice/service type (SST). The S-NSSAI may further include a 24-bit slice differentiator (SD). The SST is information indicating a service type with which a slice is associated. The SD is information for differentiating a plurality of slices associated with the same service type. The information including a plurality of pieces of S-NSSAI is referred to as a Network Slice Selection Assistance Information (NSSAI).

One or more slices may be grouped to configure a slice group. The slice group is a group including one or more slices, and a slice group identifier is assigned to the slice group. The slice group may be configured by the core network (for example, the AMF 300), or may be configured by the radio access network (for example, the gNB 200). The UE 100 may be notified of the configured slice group.

Hereinafter, the term “network slice (or slice)” may refer to an S-NSSAI that is an identifier of a single slice or an NSSAI that is a collection of S-NSSAIs, or may refer to one or more S-NSSAIs or a slice group that is a group of NSSAIs.

### Overview of Slice-Specific Cell Reselection Procedure

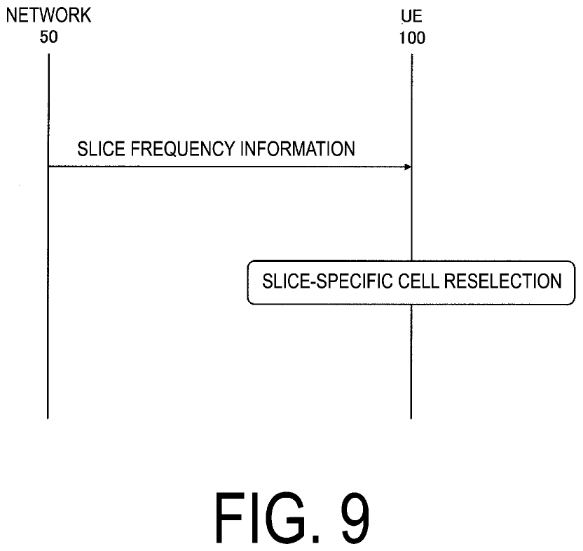

FIG. 9 is a diagram illustrating an overview of the slice-specific cell reselection procedure.

In the slice-specific cell reselection procedure, the UE 100 performs cell reselection processing based on slice frequency information provided from the network 50. The slice frequency information may be provided from the gNB 200 to the UE 100 through broadcast signaling (for example, a system information block) or dedicated signaling (for example, an RRC release message).

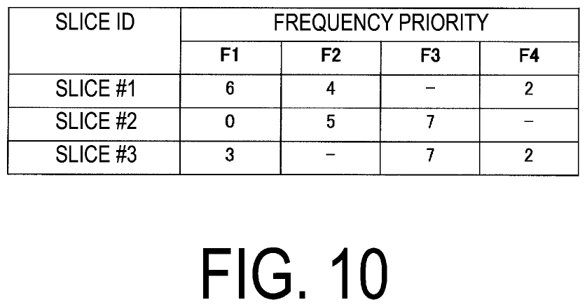

The slice frequency information is information indicating a correspondence relationship between network slices, frequencies, and frequency priorities. For example, the slice frequency information indicates, for each slice (or slice group), a frequency (one or more frequencies) that supports the slice and a frequency priority assigned to each frequency. An example of the slice frequency information is illustrated in FIG. 10.

In the example illustrated in FIG. 10, three frequencies F1, F2, and F4 are associated with the slice #1 as frequencies that support the slice #1. Among these three frequencies, the frequency priority of F1 is “6”, the frequency priority of F2 is “4”, and the frequency priority of F4 is “2”. In the example of FIG. 10, the larger the number of the frequency priority, the higher the priority is, but a case in which the smaller the number, the higher the priority is may also be possible.

Three frequencies F1, F2, and F3 are associated with the slice #2 as frequencies that support the slice #2. Among these three frequencies, the frequency priority of F1 is “0”, the frequency priority of F2 is “5”, and the frequency priority of F3 is “7”.

Three frequencies F1, F3, and F4 are associated with the slice #3 as frequencies that support the slice #3. Among these three frequencies, the frequency priority of F1 is “3”, the frequency priority of F3 is “7”, and the frequency priority of F4 is “2”.

Hereinafter, the frequency priority indicated in the slice frequency information may be referred to as a “slice-specific frequency priority” in order to be distinguished from the absolute priority in the conventional cell reselection procedure.

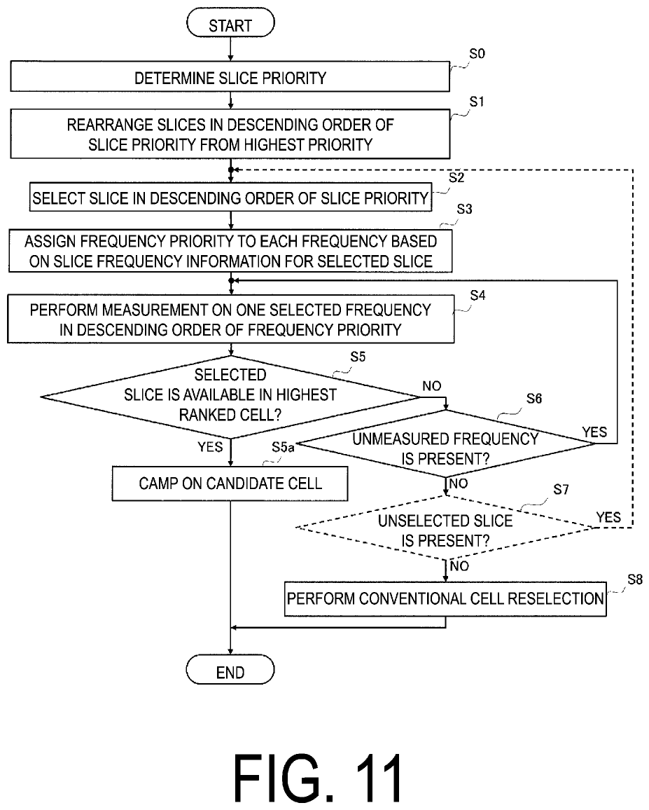

FIG. 11 is a flowchart illustrating a basic flow of the slice-specific cell reselection procedure. Before starting the slice-specific cell reselection procedure, the UE 100 is assumed to be in the RRC idle state or the RRC inactive state, and to receive and retain the above-mentioned slice frequency information.

In step S0, the NAS of UE 100 determines the slice identifiers of the desired slices for the UE 100 and the slice priorities of the desired slices, and notifies the AS of the UE 100 of slice information including the determined slice priorities. The “desired slice” includes a slice that is likely to be used, a candidate slice, a wanted slice, a slice with which communication is desired, a requested slice, an allowed slice, or an intended slice. For example, the slice priority of the slice #1 is determined to be “3”, the slice priority of the slice #2 is determined to be “2”, and the slice priority of the slice #3 is determined to be “1”. The larger the number of the slice priority, the higher the priority is, but a case in which the smaller the number, the higher the priority is may also be possible.

In step S1, the AS of the UE 100 rearranges the slices (slice identifiers), of which the AS is notified by the NAS in step S0, in descending order of slice priority. A list of the slices arranged in this manner is referred to as a “slice list”.

In step S2, the AS of the UE 100 selects one network slice in descending order of slice priority. The network slice selected in this manner is referred to as a “selected network slice”.

In step S3, the AS of the UE 100 assigns, for the selected network slice, a frequency priority to each of the frequencies associated with that network slice. To be more specific, the AS of the UE 100 specifies frequencies associated with the slice based on the slice frequency information and assigns frequency priorities to the specified frequencies. For example, when the selected network slice selected in step S2 is the slice #1, the AS of the UE 100 assigns the frequency priority “6” to the frequency F1, the frequency priority “4” to the frequency F2, and the frequency priority “2” to the frequency F4 according to the slice frequency information (for example, the information in FIG. 10). The AS of the UE 100 refers to a list of frequencies arranged in descending order of frequency priority as a “frequency list”.

In step S4, the AS of the UE 100 selects one of the frequencies in descending order of frequency priority for the selected network slice selected in step S2, and performs the measurement processing on the selected frequency. The frequency selected in this manner is referred to as a “selected frequency”. The AS of the UE 100 may rank the cells measured within the selected frequency in descending order of radio quality.

In step S5, the AS of the UE 100 specifies a cell ranked the highest based on the result of the measurement processing in step S4, and determines whether the selected network slice is available in the cell. A method for the determination is described in each operation example described below.

The AS of the UE 100, when determining that the selected network slice is available in the highest ranked cell (step S5: YES), reselects in step S5a the highest ranked cell and camps on that cell.

On the other hand, when determining that the selected network slice is not available in the highest ranked cell (step S5: NO), the AS of the UE 100 determines in step S6 whether a frequency not measured is present in the frequency list created in step S3. When determining that a frequency not measured is present (step S6: YES), the AS of the UE 100 resumes the processing for the frequency having the next highest frequency priority, and performs the measurement processing by use of that frequency as the selected frequency (returns the processing to step S4).

When determining that a frequency not measured is not present in the frequency list created in step S3 (step S6: NO), the AS of the UE 100 may determine in step S7 whether an unselected slice is present in the slice list created in step S1. When determined that an unselected slice is present (step S7: YES), the AS of the UE 100 resumes the processing for the network slice having the next highest slice priority, and selects that network slice as the selected network slice (returns the processing to step S2). Note that in the basic flow illustrated in FIG. 11, the process in step S7 may be omitted.

When determining that an unselected slice is not present (step S7: NO), the AS of the UE 100 performs conventional cell reselection processing in step S8. The conventional cell reselection processing may mean an entirety of a general cell reselection procedure illustrated in FIG. 7, or may mean only cell reselection processing (step S30) illustrated in FIG. 7. In the latter case, the UE 100 may use the measurement result in step S4 without measuring the radio qualities of the cells again.

### Operation Example of First Embodiment

In the slice-specific cell reselection described above, the UE 100 selects a cell belonging to a frequency supporting the desired slice as a serving cell. Here, in the cell belonging to the frequency supporting the desired slice, that slice is to be available, but the cell may temporarily fail to provide that slice due to congestion or the like. In this case, the UE 100 may select a cell not provided with the desired slice as a serving cell, and may not use the desired slice.

In the first embodiment, the UE 100 specifies a cell belonging to a frequency supporting the desired slice as a candidate cell in the cell reselection. The UE 100 receives slice availability information (predetermined information) for determining whether the desired slice is unavailable in the candidate cell from the network 50.

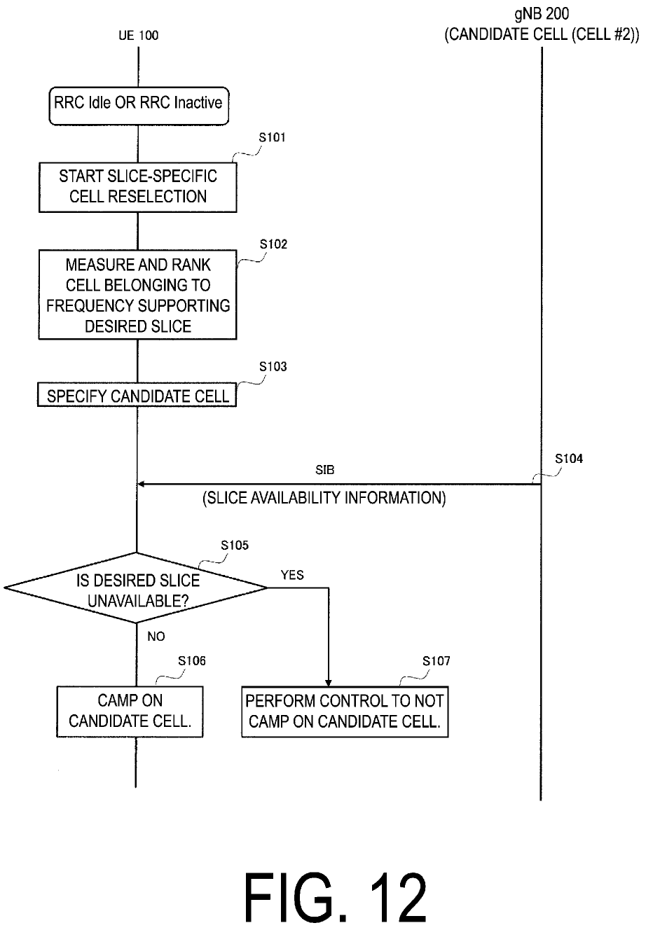

FIG. 12 is a diagram illustrating an operation example according to the first embodiment. Before starting an operation in the operation example, the UE 100 is assumed to be in the RRC idle state or the RRC inactive state, and receive and maintain the slice frequency information described above.

As illustrate in FIG. 12, in step S101, the UE 100 starts the slice-specific cell reselection procedure.

In step S102, the UE 100 measures and ranks the cell belonging to the frequency supporting the desired slice according to the slice frequency priority information. For a specific operation, refer to operations in steps S1 to S8 in FIG. 11.

In step S103, the UE 100 specifies a candidate cell to camp on. Specifically, the UE 100 specifies the highest ranked cell as the candidate cell to camp on. Here, assumed that the UE 100 specifies the cell #2, which is the neighboring cell neighboring to the cell #1 (current serving cell), as a candidate cell.

In step S104, the UE 100 receives the slice availability information broadcast from the candidate cell (cell #2). Here, the slice availability information is broadcast from the candidate cell through a master information block (MIB) or a system information block (SIB).

The slice availability information includes a slice identifier of an unavailable slice in a cell broadcasting the slice availability information. The slice availability information may further include a slice identifier of an available slice in the cell. The slice availability information may include, for each slice identifier, information indicating whether a slice identified by the slice identifier is available. When no unavailable slice is present in a cell, which may be indicated in the slice availability information broadcast by the cell. Note that in the following description, “the slice unavailable in the cell” may be interpreted as “the slice temporarily fails to be provided in the cell” or “the slice temporarily fails to be supported in the cell”.

In step S105, the UE 100 determines whether the desired slice is available in the candidate cell based on the slice availability information received in step S104. To be specific, the UE 100 determines that the desired slice is unavailable in the candidate cell when the slice identifier of the desired slice matches the slice identifier of the unavailable slice indicated by the slice availability information.

The UE 100, when determining that the desired slice is unavailable in the candidate cell (step S105: YES), performs control to not camp on the cell in step S107. For example, the UE 100 may then perform the operations of step S6 and subsequent steps in FIG. 8. The UE 100 may also lower the priority of the frequency to which the cell belongs. For example, that priority may be regarded as the lowest priority. Alternatively, the frequency priority may be removed (that is, no frequency priority is considered to be set to the frequency).

On the other hand, the UE 100, when determining that the desired slice is not unavailable (i.e., the desired slice is available) in the candidate cell (step S105: NO), reselects the cell and camps on the cell in step S106.

In the first embodiment, the UE 100 may receive the slice availability information through a dedicated RRC message. Such a dedicated RRC message includes, for example, an RRC Release message, an RRC Setup message, an RRC Reestablishment message, an RRC Resume message, or a new RRC message.

### Variation of First Embodiment

A Variation of the first embodiment is described focusing on differences from the first embodiment.

In the Variation, the slice availability information transmitted by the cell (gNB 200) not only includes the slice identifiers of the slices unavailable in the cell, but also includes slice identifiers of slices unavailable in a neighboring cell neighboring to the cell. This allows the UE 100 to determine whether the desired slice is available in the candidate cell in the cell reselection based on the slice availability information transmitted from the serving cell, and save the trouble of checking the SIB of the candidate cell.

In the Variation, cell information is transmitted and received between cells (gNBs 200) neighboring to each other (for example, transmitted and received via the Xn interface), the cell information indicating a correspondence relationship between a cell identifier and slice identifiers of slices unavailable in a cell identified by the cell identifier. This allows the cell (gNB 200) to grasp the slice identifiers of the slices unavailable in the neighboring cell. The cell information may be notified from the OAM to each gNB 200.

When the cells neighboring to each other are managed by different DUs belonging to the same gNB 200, the CU may notify the DU of cell information about neighboring DUs through an F1 message.

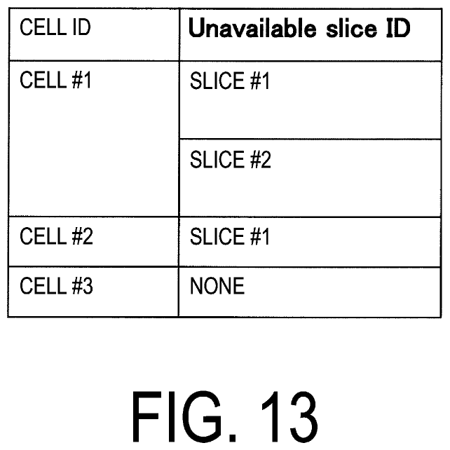

An example of the slice availability information in the Variation is illustrated in FIG. 13. The slice availability information in the example illustrated in FIG. 13 indicates that the slices #1 and #2 are unavailable in the cell #1, the slice #1 is unavailable in the cell #2, and no slice is unavailable in the cell #3.

In the Variation, the slice availability information may further include slice identifiers of slices available in the neighboring cell.

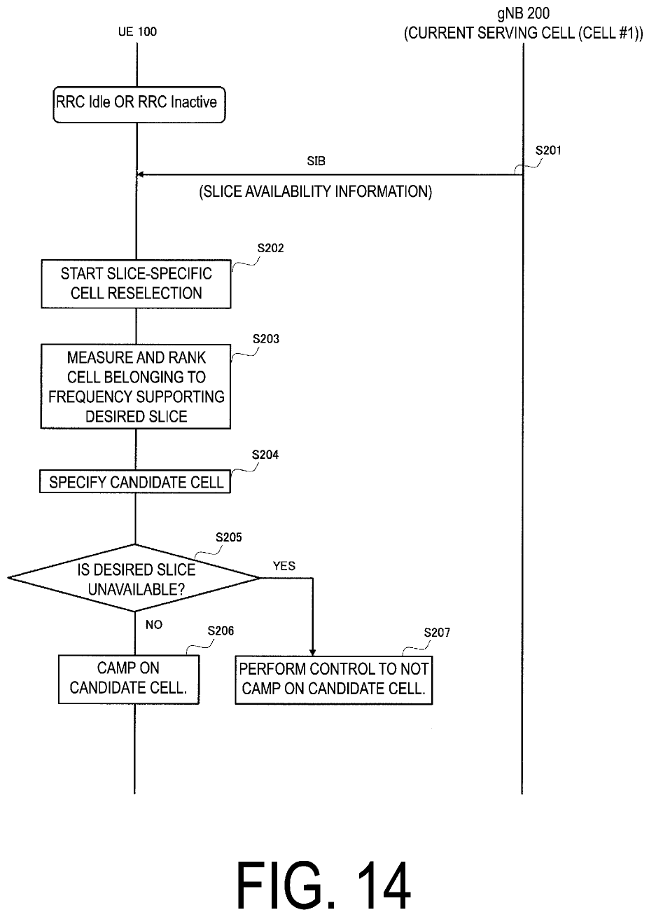

FIG. 14 is a diagram illustrating an operation in the Variation of the first embodiment.

In step S201, the UE 100 receives the slice availability information from the current serving cell (cell #1). The UE 100 maintains the received slice availability information.

Operations in steps S202 to S204 are the same as the operations in steps S101 to S103 of FIG. 12.

In step S205, the UE 100 determines whether the desired slice is unavailable in the candidate cell (cell #2) based on the slice availability information received and maintained in step S201.

Operations in steps S206 and S207 are the same as the operations in steps S106 and S107 of FIG. 12.

In the Variation of the first embodiment, the UE 100 may receive the slice availability information through a dedicated RRC message. Such a dedicated RRC message includes, for example, an RRC Release message, an RRC Setup message, an RRC Reestablishment message, an RRC Resume message, or a new RRC message.

For example, the slice availability information is included in the RRC Release message for the gNB 200 to transition the UE 100 in the RRC connected state to the RRC idle state or the RRC inactive state. The UE 100 receives the slice availability information through the RRC Release message.

In the Variation of the first embodiment, before step S203, the UE 100 may specify a cell in which the desired slice is impossible based on the slice availability information, and exclude the specified cell from the measurement target cells in step S203.

### Second Embodiment

A second embodiment will be described focusing on differences from the first embodiment.

In the 5G (NR), the system information (SI) broadcast by a cell is divided into an MIB and a plurality of SIBs. The MIB is always broadcast. Among the plurality of SIBs, SIB1 is always broadcast, but SIBs other than the SIB1 (hereinafter referred to as other SIBs) may be always broadcast or may be broadcast in response to a request from the UE 100.

Since other SIBs are not always broadcast, it is preferable to transmit the slice availability information through the SIB1 in order for the UE 100 to grasp the slice availability of the candidate cell more quickly in the cell reselection. However, the SIB1 has a limited message size, and thus, the slice availability information including each slice identifier is difficult to be included in the SIB1. Therefore, in the second embodiment, the gNB 200 transmits a slice indicator (predetermined information) indicating whether an unavailable slice is present in the cell using the SIB1, and transmits the slice availability information including the slice identifier of the unavailable slice using an SIB belonging to other SIBs (hereinafter, such an SIB may be referred to as a slice SIB).

The slice indicator does not include a slice identifier. The slice indicator is, for example, 1-bit information, where “0” indicates that no unavailable slice is present in the cell, and “1” indicates that an unavailable slice is present in the cell.

Also, the slice indicator may only indicate that an unavailable slice is present in the cell. In this case, the gNB 200 informs the UE 100 that no unavailable slice is present in the cell by not including the slice indicator in the SIB1.

Further, the gNB 200 may include the slice indicator in the MIB instead of the SIB1.

When at least one unavailable slice is present in the cell managed by the gNB 200, the gNB 200 transmits the slice indicator indicating that an unavailable slice is present in the cell.

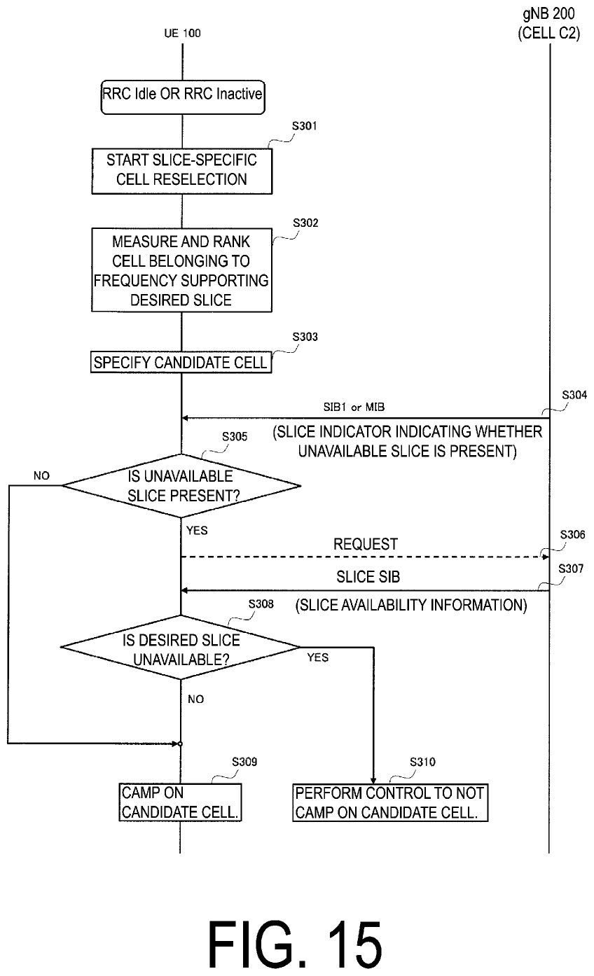

FIG. 15 is a diagram illustrating an operation example according to the second embodiment.

As illustrated in FIG. 15, operations in steps S301 to S303 are the same as the operations in step S101 to S103 of FIG. 12.

In step S304, the UE 100 receives the slice indicator indicating whether an unavailable slice is present in the candidate cell, from the candidate cell (cell #2) via the SIB1 or the MIB.

In step S305, the UE 100 determines whether an unavailable slice is present in the candidate cell (cell #2) based on the slice indicator received in step S304.

The UE 100, when determining that no unavailable slice is present in the candidate cell (step S305: NO), reselects and camps on the cell in step S309.

On the other hand, the UE 100, when determining that an unavailable slice is present in the candidate cell (cell #2) (step S305: YES), transmits a request message for requesting a slice SIB including slice availability information to the candidate cell (cell #2) in step S306. Then, in step S307, the UE 100 receives the slice SIB including the slice availability information from the candidate cell (cell #2). Note that when the slice SIB is already broadcast in the candidate cell, the operation in step S306 may be omitted. Whether the slice SIB is already broadcast in the candidate cell may be notified to the UE 100 in the SIB1 broadcast by the candidate cell.

An operation in step S308 is the same as the operation in step 105 in the figure.

The UE 100, when determining that the desired slice is unavailable in the candidate cell (step S308: YES), does not camp on the cell in step S310. On the other hand, the UE 100, when determining that the desired slice is not unavailable (i.e., the desired slice is available) in the candidate cell (step S308: NO), reselects and camps on the cell in step S309.

### Variation of Second Embodiment

A Variation of the second embodiment is described focusing on differences from the second embodiment.

In the Variation, the UE 100 omits receiving the slice availability information and controls whether to camp on the candidate cell based only on the slice indicator. This allows the UE 100 to determine a cell to camp on more quickly in the cell reselection.

For example, when the frequency supporting the desired slice supports only the desired slice (for example, in the frequency priority information, the frequency supporting the desired slice is mapped only to the desired slice), the UE 100 may determine whether the desired slice is available in the candidate cell based only on the slice indicator.

The main reason why an unavailable slice is present may be considered to be due to cell congestion. Thus, when at least one slice unavailable is present in a cell, the UE 100 may consider that other slices are also unavailable in the cell (or will soon become unavailable due to congestion) and determine that the desired slice is unavailable in the cell.

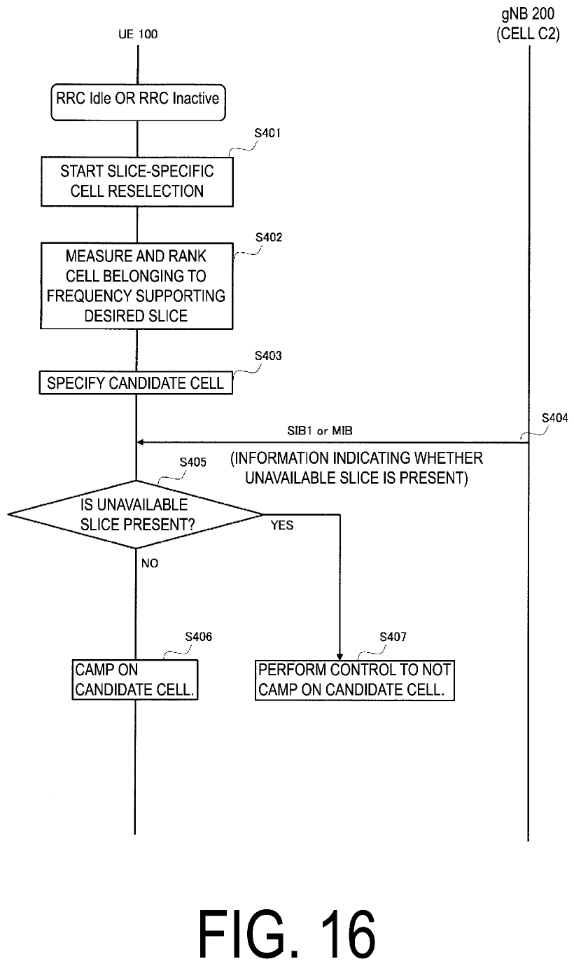

FIG. 16 is a diagram illustrating a Variation of the second embodiment.

As illustrated in FIG. 16, operations in steps S401 to S405 are the same as the operations in steps S301 to S305 in the figure.

The UE 100, when determining that no unavailable slice is present in the candidate cell (step S405: NO), reselects and camps on the cell in step S406.

On the other hand, the UE 100, when determining that an unavailable slice is present in the candidate cell (step S405: YES), performs control to not camp on the cell in step S407.

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow.

In the embodiment and examples described above, an example in which the base station is an NR base station (i.e., a gNB) is described; however, the base station may be an LTE base station (i.e., an eNB) or a 6G base station. The base station may be a relay node such as an Integrated Access and Backhaul (IAB) node. The base station may be a DU of an IAB node. The user equipment may be a Mobile Termination (MT) of the IAB node.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing the processes to be performed by the UE 100 or the gNB 200 may be integrated, and at least part of the UE 100 or the gNB 200 may be configured as a semiconductor integrated circuit (a chipset or an SoC).

Embodiments have been described above in detail with reference to the drawings, but specific configurations are not limited to those described above, and various design variation can be made without departing from the gist of the present disclosure.

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

1. A communication method performed in a user equipment in an RRC idle state or an RRC inactive state, the communication method comprising the steps of:
specifying, as a candidate cell for cell reselection, a cell belonging to a frequency supporting a selected network slice group selected in accordance with a priority provided by a NAS layer; and
determining whether the candidate cell supports the selected network slice group,
wherein the determining comprises:
receiving a system information block from a serving cell of a user equipment for each of a plurality of network slice groups, the system information block comprising information indicating an identifier of the network slice group and a cell identifier of a cell that does not support the network slice group; and
determining whether the candidate cell supports the selected network slice group, based on the information.

2. The communication method according to claim 1, further comprising a step of
receiving from the candidate, system information including an indicator indicating whether an unavailable network slice group is present in the candidate cell.

3. The communication method according to claim 2, further comprising a step of
when determining that an unavailable network slice group is present in the candidate cell, transmitting to the candidate cell, a request message for requesting a system information block including an identifier of the unavailable network slice group.

4. A user equipment comprising:
a processor configured to perform:
processing of specifying, as a candidate cell for cell reselection, a cell belonging to a frequency supporting a selected network slice group selected in accordance with a priority provided by a NAS layer; and
processing of determining whether the candidate cell supports the selected network slice group,
wherein the processing of the determining comprises:
processing of receiving a system information block from a serving cell of a user equipment for each of a plurality of network slice groups, the system information block comprising information indicating an identifier of the network slice group and a cell identifier of a cell that does not support the network slice group; and
processing of determining whether the candidate cell supports the selected network slice group, based on the information.

5. An apparatus for controlling a user equipment, the apparatus comprising a processor and a memory, the processor configured to perform:
processing of specifying, as a candidate cell for cell reselection, a cell belonging to a frequency supporting a selected network slice group selected in accordance with a priority provided by a NAS layer; and
processing of determining whether the candidate cell supports the selected network slice group,
wherein the processing of the determining comprises:
processing of receiving a system information block from a serving cell of a user equipment for each of a plurality of network slice groups, the system information block comprising information indicating an identifier of the network slice group and a cell identifier of a cell that does not support the network slice group; and
processing of determining whether the candidate cell supports the selected network slice group, based on the information to perform:
processing of specifying, as a candidate cell for cell reselection, a cell belonging to a frequency supporting a selected network slice group selected in accordance with a priority provided by a NAS layer; and
processing of determining whether the candidate cell supports the selected network slice group,
wherein the processing of the determining comprises:
processing of receiving a system information block from a serving cell of a user equipment for each of a plurality of network slice groups, the system information block comprising information indicating an identifier of the network slice group and a cell identifier of a cell that does not support the network slice group; and
processing of determining whether the candidate cell supports the selected network slice group, based on the information.
